(19) United States
(12) Patent Application Publication
(10) Pub. No.: US 2011/0192578 A1
(43) Pub. Date: Aug. 11, 2011

(54) VEHICLE COOLING SYSTEM

(76) Inventors: Mattias Lang, Ubstadt-Weiher (DE); Nicolai Tarasinski, Frankenthal (DE)

(21) Appl. No.: 11/992,244

(22) PCT Filed: Sep. 5, 2006
(86) PCT No.: PCT/EP2006/066036

§ 371 Date: Mar. 9, 2011

(30) Foreign Application Priority Data
Sep. 21, 2005 (DE) 10 2005 045 052.0

(51) Int. Cl. B60H 1/32; F28F 13/12

(52) U.S. Cl. 165/104.34

(57) ABSTRACT

The invention relates to a cooling arrangement (20) of a vehicle (10) which is moveable in a direction of travel (30), which cooling arrangement (20) comprises two heat exchanges (22, 24) and a face (26) which, during operation, sucks air through the heat exchangers (22, 24) and discharges the air at an angle with respect to the suction direction. It is proposed according to the invention that those surfaces (28) of the heat exchangers (22, 24) which are traversed by air extend at least approximately in the direction of travel (30), and that the fan (26) is arranged between the heat exchangers (22, 24).

The invention relates to a cooling arrangement of a vehicle movable in the direction of travel, which involves at least two heat exchangers and a fan warming air through the heat exchanger during operation and expelling the air at an angle to the direction of suction.

### STATE OF THE ART

A cooling system for an off-road vehicle, which involves a heat exchanger for a cooling medium of the engine or hydraulic oil and a fan that acts on the heat exchanger with an air stream, is described in U.S. Pat. No. 6,216,778 B. The fan is a radial fan that draws the air through the heat exchanger that is located on the rear side of the vehicle crosswise to the direction of travel and expels the heated air upwards.

A similar cooling system is presented in U.S. Pat. No. 5,709,175 A, in which the radial fan draws the air from the engine space through the heat exchanger that is located at the front side of the vehicle crosswise to the direction of travel and expels it upward. According to U.S. Pat. No. 5,495,909 A, the heat exchanger is also located on the front side of the vehicle crosswise to the direction of travel and the radial fan expels the air drawn through the heat exchanger toward the side of the vehicle.

It is accordingly known in the prior art to locate the heat exchanger at the front or rear side of the vehicle and to arrange its surfaces through which air flows vertically and crosswise to the forward direction of the vehicle. With the use of a radial fan, the air drawn through the heat exchanger by the fan is then deflected by 90° by the fan and expelled to the side or upward.

It can be considered disadvantageous here that the surface available for the heat exchanger is limited. This is valid in particular for vehicles in which the heat exchangers are located inside a rectangular hood region, as in farm tractors. It would indeed be possible for enhancing the cooling performance to make the heat exchanger thicker in the air flow direction, but this would cause a higher flow resistance and an overproportional fan capacity relative to the increase in cooling performance.

### PURPOSE OF THE INVENTION

The problem underlying the invention is to improve a cooling arrangement of a vehicle with a heat exchanger so that an adequate cooling capacity is achieved in a compact arrangement.

This problem is solved according to the invention by the doctrine of claim 1, where features are given in the subsequent claims that further develop the solution in an advantageous manner.

The cooling arrangement according to the invention involves at least two heat exchangers and a fan that during operation draws air through the heat exchanger and then expels it in an angle to the direction of suction. It is proposed to arrange the surfaces of the heat exchanger through which the air flows at least approximately in the direction of travel and especially vertically and to locate the fan sandwich-like between the heat exchangers. Air is thus drawn in opposite directions crosswise to the direction of travel, flows through the heat exchangers and is finally expelled by the fan in a direction turned relative to the suction direction at an angle of preferably 90°.

A compact structure of the cooling device is obtained in this manner, which structure is particularly well suited for application under a rectangular hood area of a farm tractor or a construction machine because the principal dimensions of the heat exchangers extend in the direction of travel. With a given height and breadth of the available space, the surfaces of the heat exchangers can be increased, which results in a diminished drive power of the fan that in turn causes a reduction in fan noise.

A double-flow radial fan that draws air axially from both sides and again expels it in the radial direction can be used as the fan. Alternatively, two single-flow radial fans arranged with the rear sides alongside each other, which draw air axially from one side and expel it in the radial direction can be used. The fan can have blades curved opposite to their direction of rotation or blades curved in the direction of rotation as so-called cylindrical rotors.

The drive of the fan can be from an internal combustion engine through a mechanical train. In another implementation form the fan is driven hydraulically or electrically, which offers the advantage of a variable rpm adapted to the cooling power requirement. The rpm can be controlled (adjusted or regulated) by a suitable control system to which information on the temperature of the cooling medium in the heat exchanger and the temperature of the surrounding air is given so that an rpm that is as low as possible (energy-saving) is used but the cooling power requirement is satisfied. If two single-flow radial fans arranged back-to-back are used, they have rpm's adjustable jointly or preferably separately from each other so that the two heat exchangers that can supply different units with cooling medium can be driven with the respectively suitable rpm.

In a preferred implementation form, the fan is surrounded by a guide device that involves an outlet for the air located on the upper side of the fan. Due to its lower density, the air heated in the heat exchangers rises, which promotes the conveyance action and prevents an undesirable recirculation.

### IMPLEMENTATION EXAMPLE

An implementation example of the invention described in greater detail in the following is shown in the drawings.

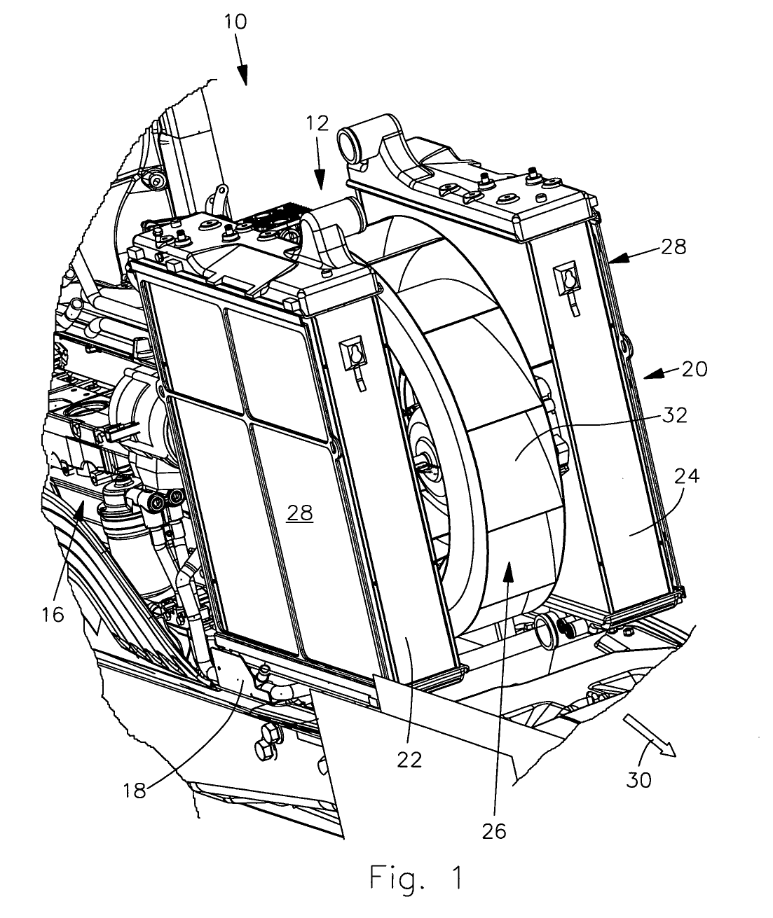

FIG. 1 shows a perspective view of a cooling arrangement according to the invention with the guide device removed for better perceptibility.

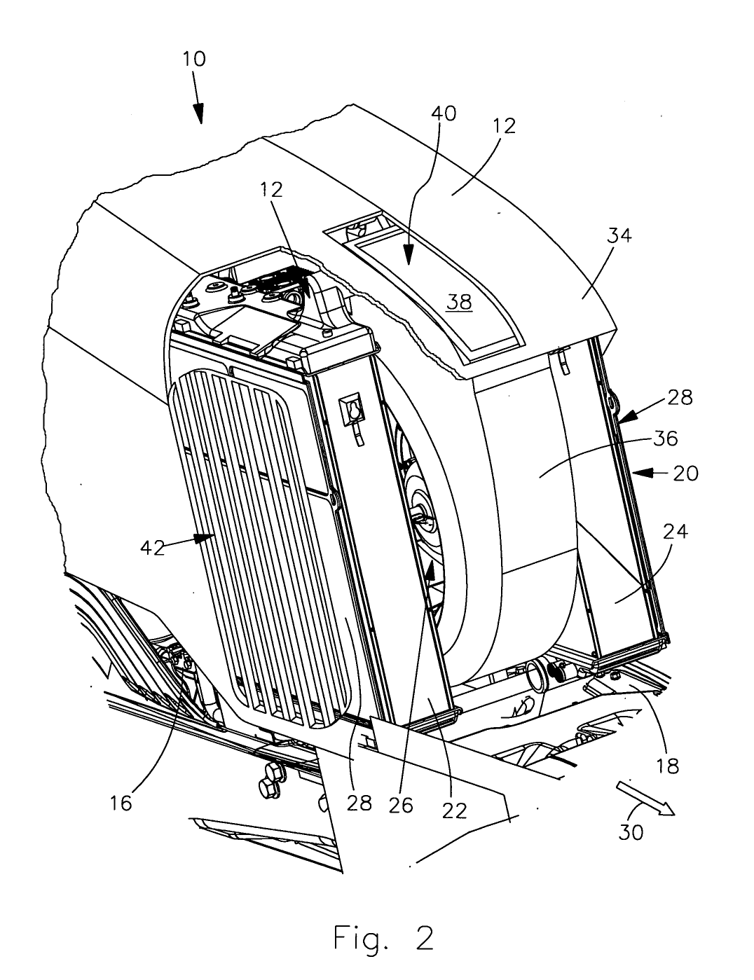

FIG. 2 shows a view of the cooling arrangement from FIG. 1 with the guide device applied.

FIG. 1 shows the front region of a vehicle 10 in the form of a farm tractor, which involves a rectangular hood region 12 that is enclosed by braces (not shown), which serve to support a hood 34 (see FIG. 2). An internal combustion engine 16 is located at the back of the hood region 12. A holding device 18 that carries a cooling arrangement 20 according to the invention is connected to the frame (not shown) of the vehicle 10.

The cooling arrangement 20 comprises a first heat exchanger 22 designed as a known countercurrent heat exchanger, a second heat exchanger 24 designed as a known countercurrent heat exchanger, and a fan 26. The first heat exchanger 22 is located on the right side of the hood region 12 relative to the direction of travel and has a surface 28 through which air flows and which extends vertically and in the travel direction 30 of the vehicle 10. The second heat exchanger 24 is located on the left side of the hood region 12 relative to the travel direction and has a surface 28 through which air flows and which extends vertically and in the travel direction 30 of the vehicle 10. The fan 26 that is a double-flow radial fan with trailing curved blades 32 and an axis of rotation extending horizontally and crosswise to the travel direction 30 is located between the heat exchangers 22, 24.

Reference is now made to FIG. 2, in which the front region of the vehicle 10 is shown with the hood 34 applied. The fan 26 is now provided with a matching guide device 36 that encloses it radially and allows for only one exit 38 at the upper side of the fan 26, which is oriented with an opening 40 in the hood 34. The hood 34 also comprises lateral openings 42 that are oriented with the surfaces 28 of the heat exchangers 22 and 24. Sieves or grids can be present in these openings 42 to prevent the penetration of at least larger foreign bodies.

The functioning of the cooling arrangement 20 is as follows:

The fan 26 is made to rotate around its axis by an appropriate drive (electrically or hydraulically or mechanically by the internal combustion engine 16). Due to its rotation with its trailing curved blades 32, it draws in relatively clean air streams from both sides, which streams are oriented axially to the rotation direction of the fan 26 and accordingly flow horizontally and crosswise to the travel direction 30 through the openings 42 and through the surfaces 28 of the heat exchangers 22 and 24 and through the latter to the fan 26. The fan 26 impels the drawn-in air in the radial direction. The guide device 36 causes the drawn-in, heated air to be expelled upward only through the exit 38 and the opening 40 at the upper side of the fan 26.

The heat exchangers 22, 24 can be flowed through by any cooling media of the vehicle impelled in particular by pumps, compressors or turbines, e.g., the cooling water of the internal combustion engine, the oil of the combustion engine or of a transmission, hydraulic oil, charge air of a turbo-supercharger (charge air cooler), cooling fluid of an electric motor and/or the cooling agent of a condenser of an air-conditioning unit. In a preferred implementation form, each of the heat exchangers 22, 24 is flowed through by a cooling medium that is assigned to a cooling circuit of another unit of the vehicle 10, especially one of the aforementioned cooling circuits. The heat exchangers 22, 24 can be comprised of separate heat exchangers that are arranged in the travel direction 30 one after the other and/or vertically one above the other and that are assigned to different cooling circuits.

1. Cooling arrangement (20) of a vehicle (10) movable in a travel direction (30), which comprises at least two heat exchangers (22, 24) and a fan (26) drawing air during operation through the heat exchangers (22,24) and expelling the air at an angle to the direction of suction, characterized in that the surfaces (28) of the heat exchangers (22, 24) through which air flows extend at least approximately in the travel direction (30) and in that the fan (26) is located between the heat exchangers (22, 24).

2. Cooling arrangement (20) according to claim 1, characterized in that the surfaces (28) of the heat exchangers (22, 24) through which air flows are arranged approximately vertically.

3. Cooling arrangement (20) according to claim 1 or 2, characterized in that the fan (26) comprises a double-flow radial fan or two single-flow radial fans arranged back-to-back.

4. Cooling arrangement (20) according to one of claims 1-3, characterized in that the fan (26) has blades (32) curved contrary to or in the direction of rotation.

5. Cooling arrangement (20) according to one of claims 1-4, characterized in that the fan (26) is surrounded by a guide device (36) that comprises an exit (38) located on the upper side of the fan (26) that preferably conveys the hot exhaust air upward to prevent recirculation.

6. Cooling arrangement (20) according to one of claims 3-5, characterized in that the double-flow radial fan has an adjustable rpm or that the two single-flow radial fans arranged back-to-back have rpm's adjustable jointly or separately from each other.

7. Cooling arrangement (20) according to one of claims 1-6, characterized in that the two heat exchangers (22, 24) are located in separate cooling circuits that supply different units with cooling medium.

8. Vehicle (10), especially a farm tractor with a cooling arrangement (20) according to one of claims 1-7.

9. Vehicle (10) according to claim 8, characterized in that the cooling arrangement (20) is located under a somewhat rectangular hood region (12).
